(19) United States
(12) Patent Application Publication
(10) Pub. No.: US 2013/0185206 A1
(43) Pub. Date: Jul. 18, 2013

(54) Real-Time System for Approving Purchases Made with a Mobile Phone

(71) Applicants: Jacquelle Dequan Leggett, Raleigh, NC (US); Philippa Mignon Rhodes, Raleigh, NC (US)

(72) Inventors: Jacquelle Dequan Leggett, Raleigh, NC (US); Philippa Mignon Rhodes, Raleigh, NC (US)

(73) Assignee: International Business Machines Corporation, Armonk, NY (US)

(21) Appl. No.: 13/351,082

(22) Filed: Jan. 16, 2012

(51) Int. Cl. G06Q 20/40; G06Q 20/32

(52) U.S. Cl. 705/44

(57) ABSTRACT

An approach is provided to approving purchases made with a mobile device. In this approach, a purchase request relating to an item is received at the mobile device, with the purchase request including item data associated with the item. The item data is compared to a set of predetermined authorized criteria. If the item data falls within (meets) the predetermined authorized criteria, then a payment authorization is generated. On the other hand, if the item data not meet the predetermined authorized criteria, then a real-time interactive purchase request is sent from the device over a network to an authorizing agent with the purchase request including the item data. A response is received from the authorizing agent. If the response is a purchase approval, then the payment authorization is generated.

### TECHNICAL FIELD

The present disclosure relates to an approach that provides limits and approvals for purchases made using a mobile telephone.

### BACKGROUND OF THE INVENTION

Mobile phone manufacturers and credit card companies have created and enabled the ability to use a mobile phone to make purchases by moving a mobile device, such as a smart mobile phone, in a location proximate to a payment device located in a merchant location. Some smart mobile phones and credit card reading devices have been enabled with near-field communication (NFC) technology. NFC is a short range wireless technology that allows two-way communication between the smart mobile phones and a device located in the merchant's store, typically installed near a traditional cash register at the checkout location of the merchant.

### SUMMARY

An approach is provided to approving purchases made with a mobile device. In this approach, a purchase request relating to an item is received at the mobile device, with the purchase request including item data associated with the item. The item data is compared to a set of predetermined authorized criteria. If the item data falls within (meets) the predetermined authorized criteria, then a payment authorization is generated. On the other hand, if the item data not meet the predetermined authorized criteria, then a real-time interactive purchase request is sent from the device over a network to an authorizing agent with the purchase request including the item data. A response is received from the authorizing agent. If the response is a purchase approval, then the payment authorization is generated.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing interactions between component devices utilized in a real-time system that approves purchase made with a mobile device;

FIG. 4 is a flowchart showing steps performed by an approver in setting predetermined authorized criteria used by the mobile device;

FIG. 5 is a flowchart showing steps performed at the mobile device and the approver device to provide real-time interactive purchase approvals;

FIG. 6 is a flowchart showing steps performed at a merchant checkout device and the mobile device when purchasing an item; and

FIG. 7 is a flowchart showing steps performed at the mobile device in checking predetermined authorized criteria; and

FIG. 8 is a flowchart showing steps performed at the mobile device to identify a preferred payment method for the purchase.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

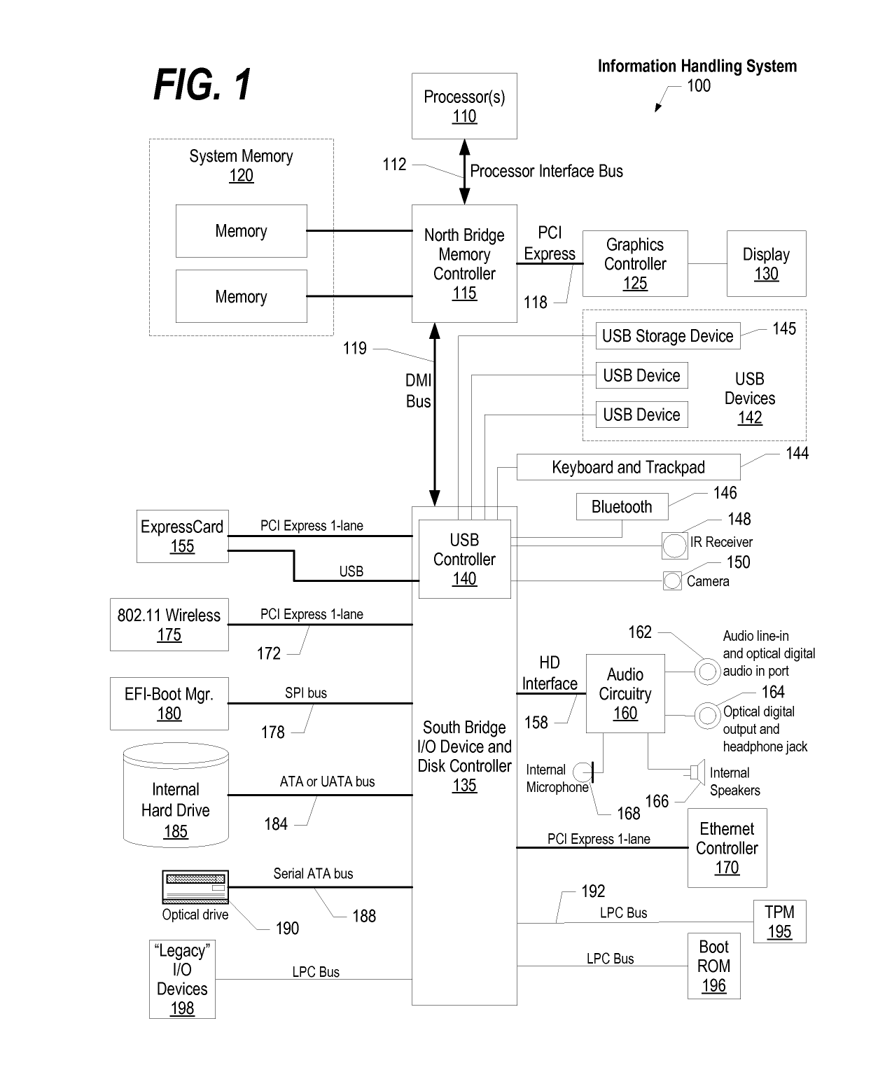

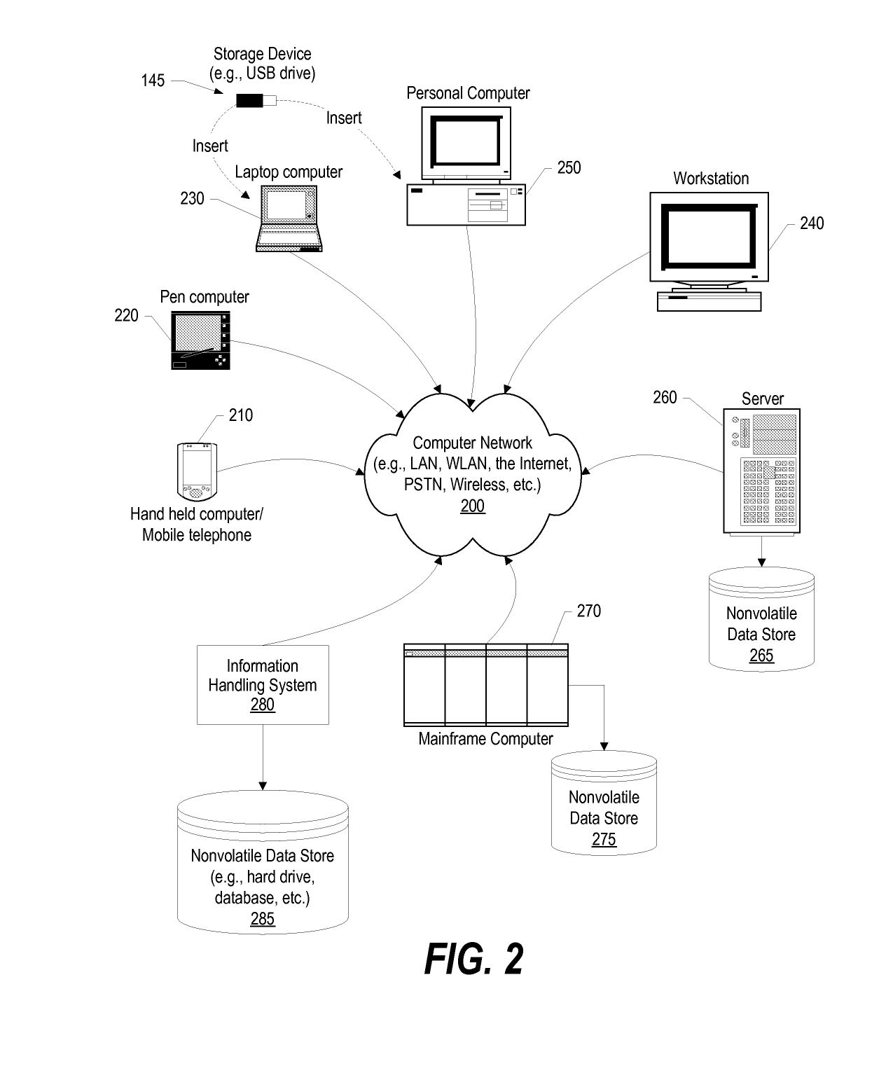

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

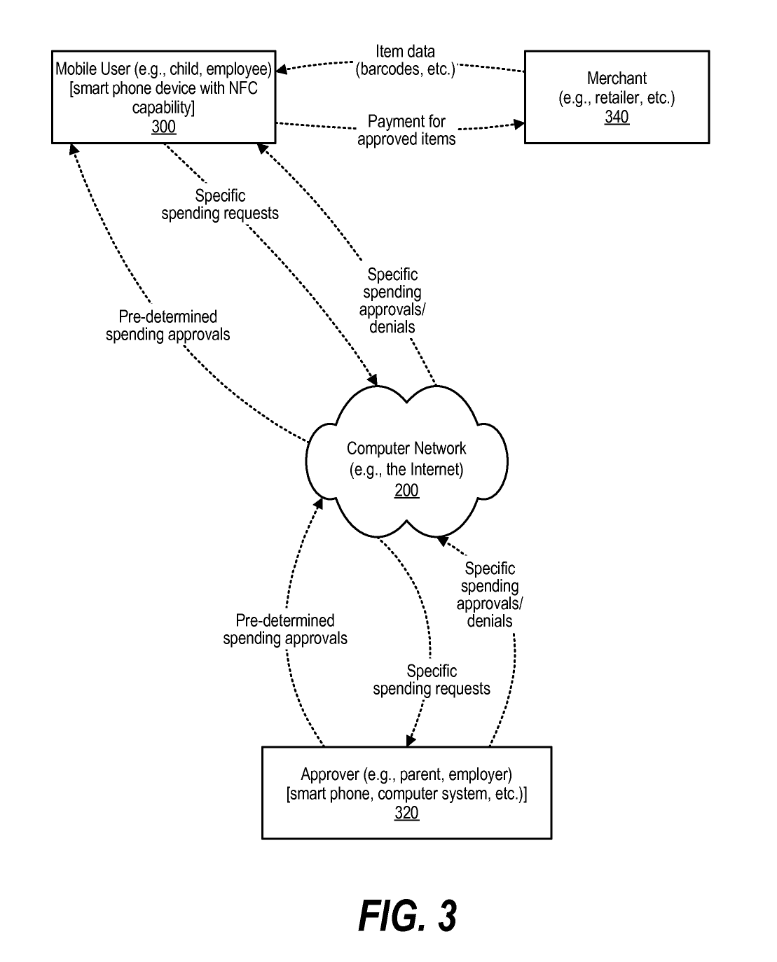

FIGS. 3-8 describe an approach that places the power of making purchasing decisions in the hands of individual approvers. These individual approvers may be parents, employers, managers, and the like. Mobile phone manufacturers and credit card companies have created and enabled the ability to use a mobile phone to make purchases, not by calling an order center and entering a credit card number, but by waving a mobile phone near a device in a store. Some mobile phones and credit card reading devices have been enabled with near-field communication (NFC) technology, a short range wireless technology that allows 2-way communication. The approach described in FIGS. 3-8 takes advantage of the 2-way communication capability in order to monitor and restrict the types of purchases that can be made with the banking systems (e.g., credit card accounts, debit cards, etc.) registered with a mobile device, such as a smart phone. This approach allows an “approver”, such as a parent or employer, to monitor, approve, or reject the purchase of single items of a “buyer”, such as a child or employee. In traditional purchasing settings, an approver can only impose a spending limit or is left to trust that a buyer will only make agreed upon purchases. When the banking application data is registered with a mobile device, such as the user's smart phone, the approver (e.g., a parent, employer, etc.) can set predetermined authorized criteria that restrict purchases made by the buyer (the user of the mobile device, such as a child, employee, etc.). If the buyer wants to make a purchase outside of these parameters, the mobile device can be used to make a real-time interactive purchase request on a case-by-case basis. These special approvals take place real-time, while the buyer is shopping. If approval is not granted by the approver (e.g., with a response returned from the approver's information handling system, etc.), then the user's mobile device will reject authorization for the purchase, however if approval is granted, then the user's mobile device will allow the purchase when the user is checking out of the merchant's store. In addition, with both the predetermined authorized criteria and the real-time interactive purchase authorizations can indicate a particular payment method (e.g., use of a particular credit card when the buyer is purchasing clothing, use of a debit card when the buyer is purchasing food, etc.) that is to be used to purchase particular items.

FIG. 3 is a diagram showing interactions between component devices utilized in a real-time system that approves purchase made with a mobile device. Mobile device 300, such as a smart mobile phone with near-field communication (NFC) capabilities, is used by a user, such as a child or employee. In one embodiment, the user receives approval from approver 320, such as a parent, manager, employer, etc. Approvals to purchase an item can be both predetermined as well as real-time interactive approvals.

Mobile user 300 utilizes an input component to scan an item identifier. An input component is a component such as a camera, barcode scanner, etc., that is included or accessible from the mobile device. An item identifier identifies the item that the user is interested in purchasing. The item identifier can be the universal product code (UPC), a model number, or any identifier that sufficiently identifies the product that the user wishes to purchase. The item corresponds to various types of item data including the identifier as well as types of data such as item name, item description, item photograph, item price, etc. The mobile device used by mobile user 300 receives the item identifier from merchant 340, such as by reading a barcode affixed to the item, etc.

The mobile device includes predetermined authorized criteria (e.g., individual item spending limits (no individual items above $100 without specific approval), allow purchases at gas stations, limit spending to an amount per time interval, such as $300 per week, etc., allow certain categories of items, such as school supplies, and disallowing other categories of items, such as cigarettes, alcohol, video games, etc.). The system compares the item data corresponding to the item with the predetermined authorized criteria. If the item data meets the predetermined criteria, then mobile user 300 is allowed to purchase the item without further approvals. The mobile user can use the mobile device to purchase the item by utilizing the mobile device's NFC capabilities to transmit payment data to a merchant device. The merchant's device uses NFC to wirelessly transmit the item data to the mobile device and then receives the payment (e.g., banking data, etc.) via a wireless transmission from the mobile device.

If an item does not meet the predetermined authorized criteria, mobile device 300 sends a spending request to approver 320, such as a parent, manager, employer, etc. The spending request is a real-time interactive purchase request that is wirelessly transmitted through a network from the user's mobile device 300 to the approver's device 320 utilizing a computer network, such as the Internet. Approver 320 receives item data, such as the price of the item, category of the item, merchant name/location, description of the item, and photograph of the item. In addition, mobile user 300 may include text justifying the purchase request such as why the mobile user needs to make this purchase from this merchant at this time. Approver 320 analyzes the received item data and makes a decision as to whether to allow or deny the purchase request. A purchase approval, if received by mobile user 300, allows the user to purchase the specific item requested. Conversely, a denial prevents user 300 from purchasing the item using the user's mobile device. When the user attempts to purchase the item from merchant 340, the merchant will transmit the item identifier and any item data to mobile user's device 300 and the mobile device will transmit payment data if specific payment authorization was received from the approver relating to the item.

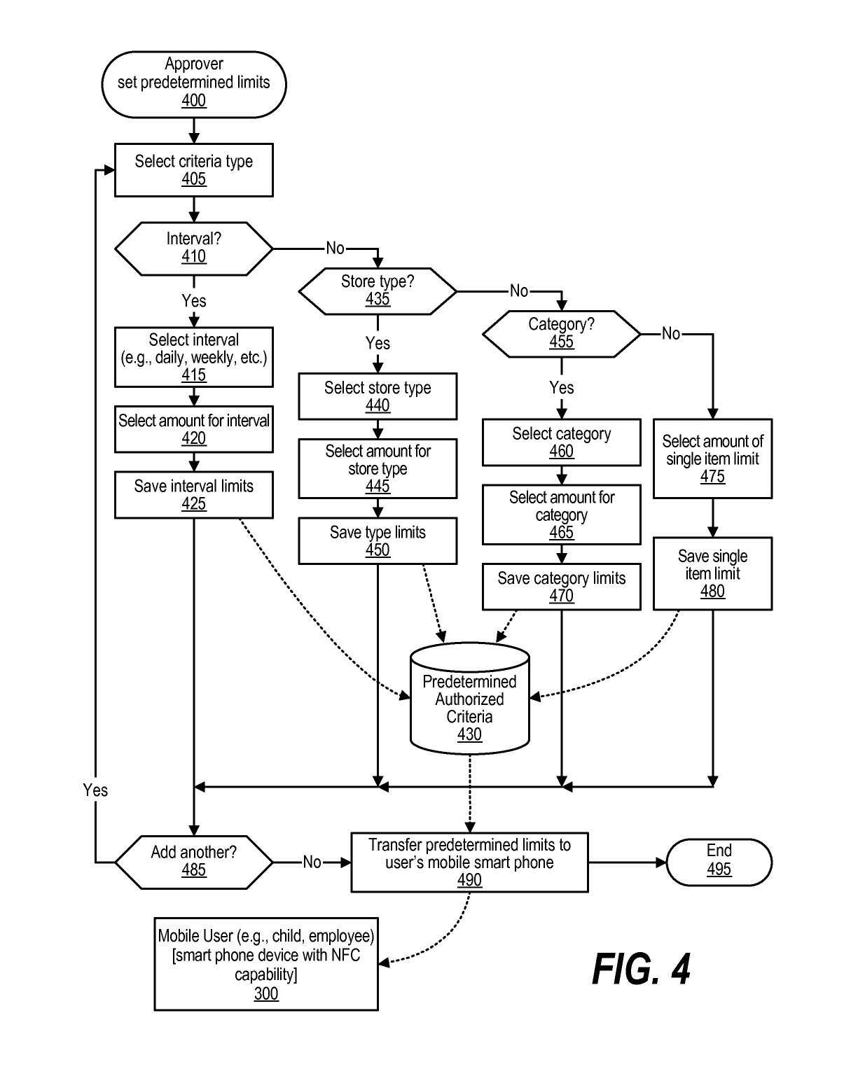

FIG. 4 is a flowchart showing steps performed by an approver in setting predetermined authorized criteria used by the mobile device. The predetermined authorized criteria can be captured on the mobile device utilized by the user, or can be transmitted from the approver's device to the mobile device utilized by the user. When captured on the user's mobile device, the approver can configure the predetermined authorized criteria by entering a password or token known to the approver and not known by the user. When captured on the approver's device, the predetermined authorized criteria can be transmitted from the approver's device to the user's mobile device (e.g., over a computer network, such as the Internet, and wirelessly transmitted to the user's mobile device, etc.).

Processing performed by the approver in establishing the predetermined authorized criteria in FIG. 4 commences at 400 whereupon, at step 405, the system receives the first predetermined authorized criteria type from the approver. A decision is made as to whether the predetermined authorized criteria type is an interval type (decision 410).

If the predetermined authorized criteria type selected by the approver is an interval type, then decision 410 branches to the “yes” branch to process the predetermined interval-type authorization criteria. At step 415, the approver selects the type of interval (e.g., daily interval for a daily spending limit, weekly interval for a weekly spending limit, monthly interval for a monthly spending limit, etc.). At step 420, the approver selects the spending limit amount for the selected interval (e.g., daily limit of $50, weekly limit of $200, monthly limit of $500, etc.). At step 425, the predetermined authorized interval-type criteria are saved to predetermined authorized criteria data store 430. Steps 415 through 425 can be performed multiple times in order to establish different predetermined interval-type authorized criteria, each with different spending limits.

Returning to decision 410, if the approver's predetermined authorized criteria type is not an interval type criteria, then decision 410 branches to the “no” branch whereupon a decision is made as to whether the approver is selecting a store type at which the user can purchase items (decision 435). If the approver selects a store type, then decision 435 branches to the “yes” branch to process the predetermined store-type authorization criteria. At step 440, the approver selects a store type which can be a particular store brand (e.g., Walmart, etc.) or a type of store (e.g., convenience store, gas station, etc.). At step 445, the approver selects the amount that the user is allowed to spend at the selected store type. The approver can disallow a particular store type by making the amount zero ($0.00). For example, if the approver does not want the user to spend any money in video game stores, the approver can set the store type of “video game store” to zero ($0.00). At step 450, the predetermined authorized store type criteria are saved to predetermined authorized criteria data store 430.

Returning to decision 435, if the approver's predetermined authorized criteria is not an interval-type or a store-type, then decision 435 branches to the “no” branch whereupon a decision is made as to whether the approver is selecting a category for spending limits (decision 455).). If the approver selects a category type, then decision 455 branches to the “yes” branch to process the predetermined item category-type authorization criteria. At step 460, the approver selects an item category such as “clothing,” “food,” “entertainment,” “automotive,” and the like. At step 465, the approver selects the amount that the user is allowed to spend on the selected type of item category. For example, the approver can approve the user to spend up to $100 on “clothing.” In addition, the approver can disallow a particular type of item from being purchased by making the amount zero ($0.00). For example, if the approver does not want the user to purchase video games, the approver can set the item category of “video game” to zero ($0.00). At step 470, the predetermined authorized item category criteria are saved to predetermined authorized criteria data store 430.

Returning to decision 455, if the approver is not selecting an item category for the predetermined authorized criteria, then decision 455 branches to the “no” branch whereupon any single item spending limit is identified. At step 475, the approver selects a maximum amount that the user can spend on a single item without receiving specific approval from the approver. For example, the approver may decide that the user can not purchase any single item that costs more than $100 without getting specific approval for the item. At step 480, the single item spending limit is saved in predetermined authorized criteria data store 430.

A decision is made as to whether the approver wishes to establish another predetermined authorized criteria type (decision 485). If the user wishes to establish another predetermined authorized criteria type, then decision 485 branches to the “yes” branch which loops back to step 405 to receive the approver's next predetermined authorized criteria selection and corresponding details as described above. This looping continues until the approver does not wish to enter any more predetermined authorized criteria types, at which point decision 485 branches to the “no” branch. At step 490, the predetermined authorized criteria stored in data store 430 are transferred to the user's mobile device 300 (e.g., wirelessly, through a computer network such as the Internet, etc.). If predetermined authorized criteria data store 430 was established on the user's mobile device, then the predetermined authorized criteria is now available for use when the user wishes to purchase an item. The process used by the approver to establish the predetermined authorized criteria thereafter ends at 495.

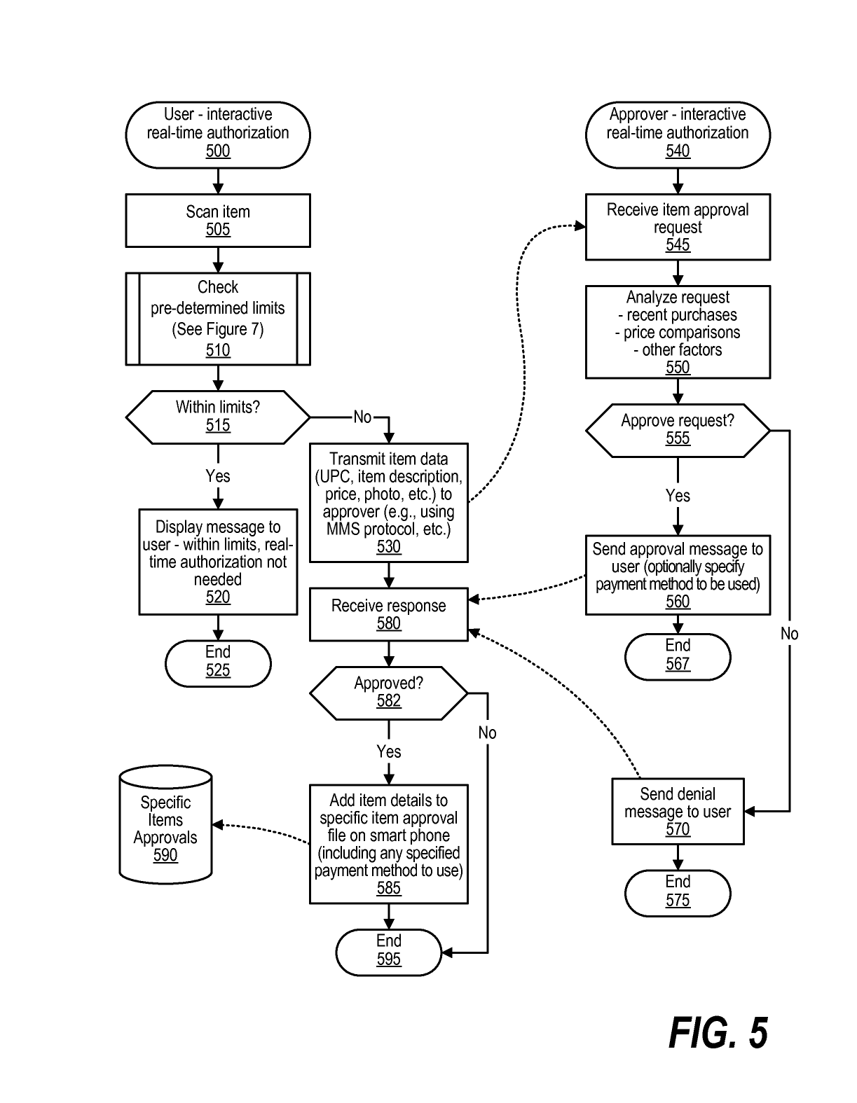

FIG. 5 is a flowchart showing steps performed at the mobile device and the approver device to provide real-time interactive purchase approvals. User processing at the mobile device commences at 500 whereupon, at step 505, the user selects an item that the user is interested in purchasing and scans the item (e.g., using a digital camera, scanner, etc. included in the mobile device, such as a mobile smart phone, etc.). The mobile device receives the purchase request relating to the item selected by the user with the purchase request including data items relating to the item, such as an item identifier (e.g. UPC code, etc.) corresponding to the item, the item price, etc.

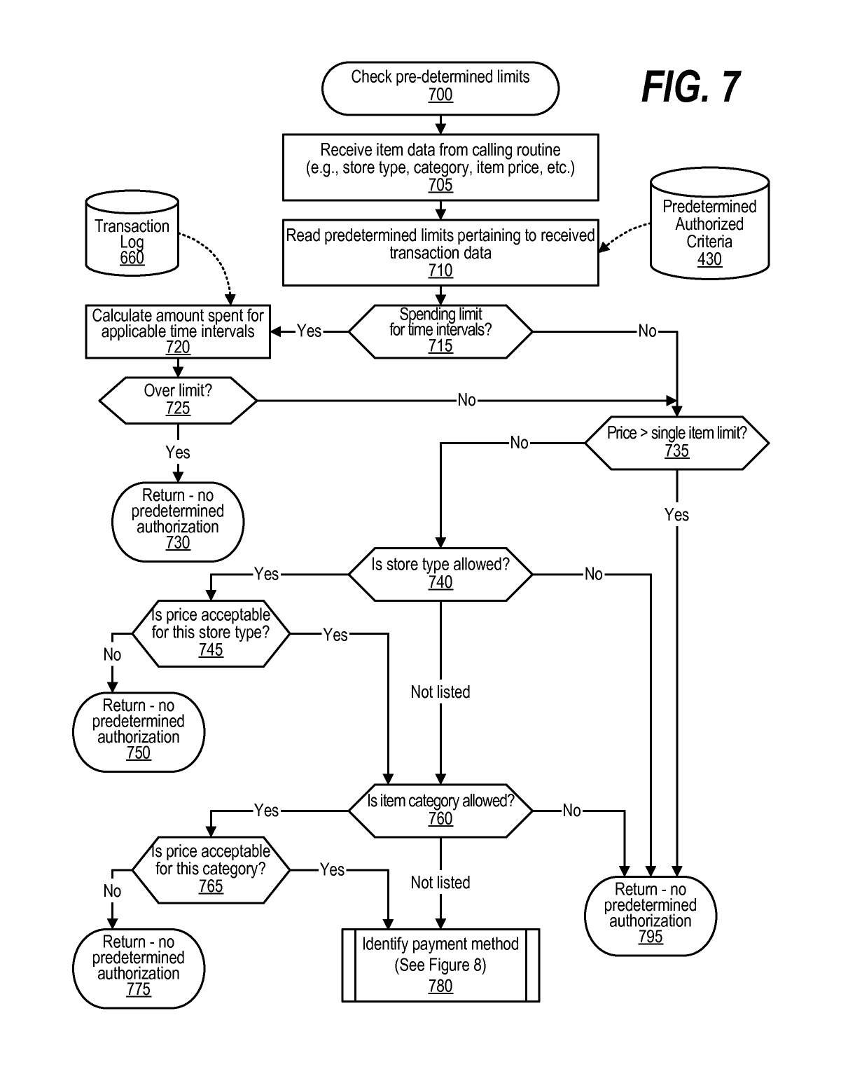

At predefined process 510, the system (e.g., operating on the user's mobile device or communicating over a network with a process running on a remote system, etc.) checks the predetermined authorized criteria that has been set for the user that is using the mobile device (see FIG. 7 and corresponding text for processing details). A decision is made as to whether the item data meets the predetermined authorized criteria (decision 515). For example, if the item is an article of clothing for $50 and the predetermined authorized criteria has been set to allow the user to purchase clothing less than $100 than the item data would meet (be within) the predetermined authorized criteria. On the other hand, if the predetermined authorized criteria was set to disallow such a purchase, then predefined process 510 would indicate that the item data did mot meet the predetermined authorized criteria. If the item data meets the predetermined authorized criteria, then decision 515 branches to the “yes” branch whereupon, at step 520, a message is displayed to the user that the item data is within the predetermined authorized criteria and that real-time interactive authorization is not needed to purchase the item and processing ends at 520.

On the other hand, if the item data does not meet (fall within) the predetermined authorized criteria, then decision 515 branches to the “no” branch to perform interactive real-time authorization. At step 530, the item data (e.g., UPC code, item description, price, photo of the item, store name and location, etc.) are transmitted to the approver and interactive real-time authorization is requested. In one embodiment, the request at step 530 is transmitted through the mobile device's wireless communication adapter through a telephone or computer network, such as the Internet, to the approver's device.

Approver processing is shown commencing at 540 whereupon, at step 545, the item approval request is received from the mobile device with a request for real-time authorization. The approver may utilize any information handling system capable of receiving and processing the request, such as another mobile device, a desktop computer system, etc. At step 550, the approver analyzes the received request. In one embodiment, the request from the user's mobile device further includes recent purchase history data informing the approver of other purchases recently made by the user of the mobile device. The approver's analysis may also perform a price comparison of the requested item, such as at online vendors, other merchants, and the like. A decision is made by the approver as to whether to approve the mobile device user's request to purchase the item based upon the analysis performed by the approver (decision 555). If the approver decides to approve the request, then decision 555 branches to the “yes” branch whereupon, at step 560, a purchase approval is sent from the approver's device back to the user's mobile device. In addition, the approver can specify a payment method that is to be used to make the specifically-approved purchase. For example, if the purchase is rather expensive, the approver may decide to specify a low-interest credit card or may opt for a credit card that provides the best benefit (e.g., airline miles, etc.). Approver processing thereafter ends at 567. On the other hand, if the approver decides to deny the request, then decision 555 branches to the “no” branch whereupon, at step 570, a denial message is sent from the approver's device back to the user's mobile device and approver processing ends at 575.

Returning to processing performed at the user's mobile device, at step 580 the user's device receives a response from the authorizing agent (the approver's device). A decision is made as to whether the real-time interactive response from the authorizing agent included a purchase approval (decision 582). If the response included a purchase approval, then decision 582 branches to the “yes” branch whereupon, at step 585, the user's mobile device adds the item details (e.g., item identifier, etc.) to specific items approval data store 590. In addition, if the approver identified a specific payment method to use when making the purchase, then the identified payment method (e.g., a specific credit card, debit card, etc.) is included with the item details. The specific items approval data store will be used when the user actually purchases the items from the merchant. If the response from the authorizing agent did not include a purchase approval, then decision 582 branches to the “no” branch bypassing step 585. Processing performed at the user's device to authorize the purchase of an item thereafter ends at 595.

The communication between the mobile device user (e.g., the child, employee, etc.) and the approver (e.g., the parent, employer, manager, etc.) can be accomplished using textual messages between the user's mobile device and a system being used by the approver. In one embodiment, the communication is a verbal communication whereupon the approver receives a telephone call from the user's mobile device and is prompted to provide a voice response which is sensed and processed by the user's mobile device.

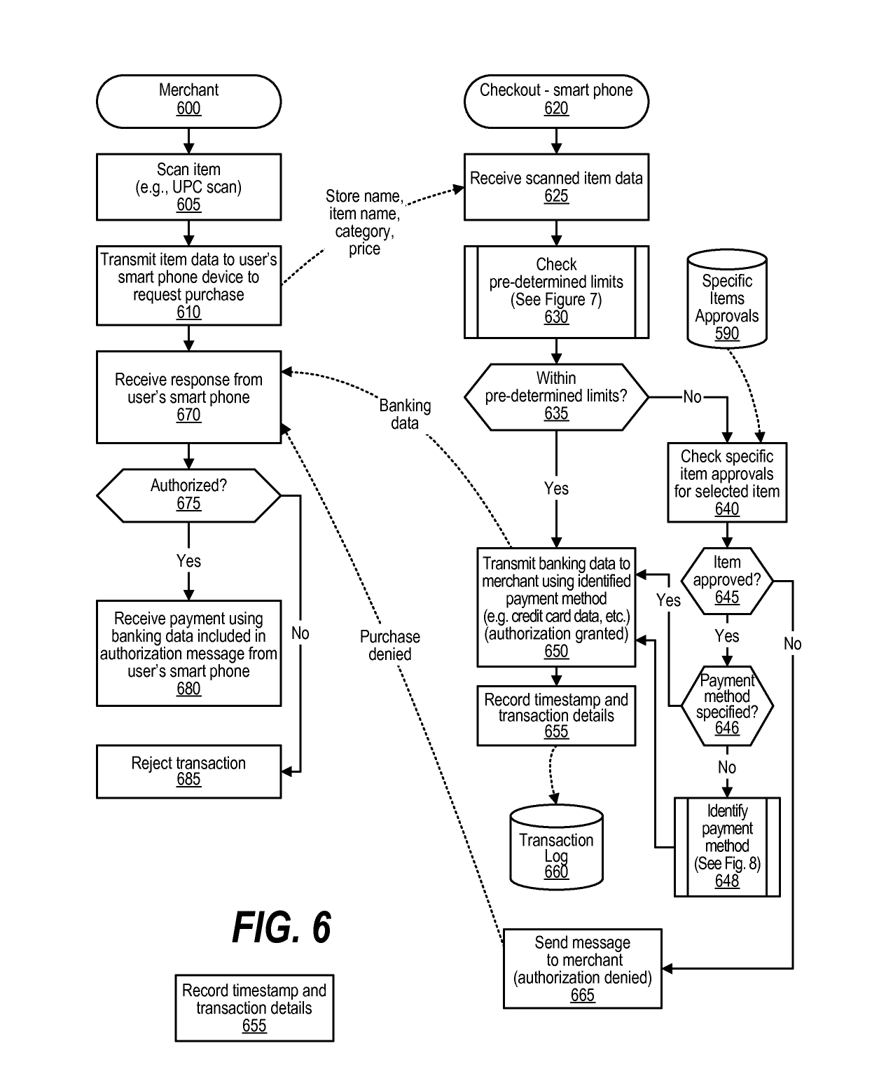

FIG. 6 is a flowchart showing steps performed at a merchant checkout device and the mobile device when purchasing an item. Merchant processing commences at 600 whereupon, at step 605, the merchant scans the item selected by the user of the mobile device (e.g., at a register, etc.). At step 610, the merchant device (e.g., point-of-sale terminal, etc.) transmits item data related to the scanned item to the user's mobile device (e.g., smart mobile phone, etc.) using Bluetooth technology, near-field communication (NFC) technology, etc.

Checkout processing performed by the user's mobile device commences at 620 whereupon, at step 625, the user's mobile device receives a payment request for the scanned item along with the item data (e.g., item identifier, description, store name, location, etc.). At predefined process 630, the system (e.g., operating on the user's mobile device or communicating over a network with a process running on a remote system, etc.) checks the predetermined authorized criteria that has been set for the user that is using the mobile device (see FIG. 7 and corresponding text for processing details). A decision is made as to whether the item data meets the predetermined authorized criteria (decision 635). If the item does not meet the predetermined authorized criteria, then decision 635 branches to the “no” branch whereupon, at step 640, the user's mobile device checks specific items approval data store 590 in order to determine whether the user received specific approval to purchase this item from the authorizing agent (e.g., the user's parent, manager, employer, etc.). A decision is made as to whether the item has been specifically approved for purchase (decision 645). If the item data did not meet the predetermined authorized criteria and the item was not specifically approved for purchase, then decision 645 branches to the “no” branch whereupon, at step 665, a message is returned to the merchant device indicating that the item is not approved and that authorization to purchase the item is denied without transmitting payment information to the merchant device.

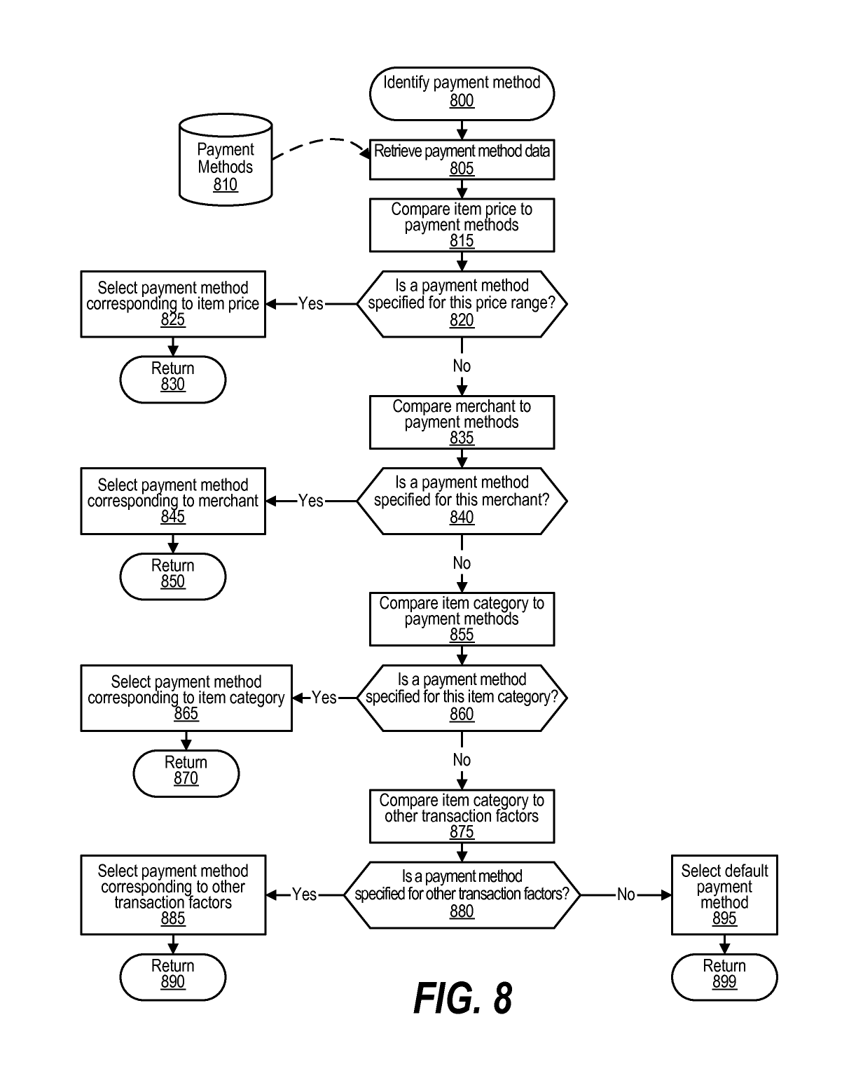

On the other hand, if the item has been specifically approved for purchase, then decision 645 branches to the “yes” branch whereupon a decision is made as to whether the approver identified a specific payment method that is to be used to make the purchase (decision 646). If the approver identified a specific payment method, then decision 646 branches to the “yes” branch to continue checkout processing. On the other hand, if the approver did not identify a specific payment method to use to make the purchase, then decision 646 branches to the “no” branch whereupon, at predefined process 646, the payment method that is to be used for the transaction is identified based on the transaction details (see FIG. 8 and corresponding text for processing details).

If the item being purchased is within the pre-determined limits (with decision 635 branching to the “yes” branch) or if the item being purchased was specifically approved (with decision 645 branching to the “yes” branch), then checkout processing continues at step 650. At step 650, banking data is transmitted to the merchant device (e.g., a credit card number, debit card number, online funds transfer, etc.) using the identified payment method (either specifically identified by the approver or previously identified using the process shown in FIG. 8). At step 655, the transaction is recorded in transaction log 660 along with a timestamp indicating the time/date of the transaction.

Returning to merchant processing, at step 670 the merchant device receives a response from the user's mobile device. A decision is made as to whether the response indicates that the purchase is approved (decision 675). If the purchase was approved by the user's mobile device, then decision 675 branches to the “yes” branch whereupon, at step 680, the merchant device receives payment information that was included in the approval transmission received from the user's mobile device. On the other hand, if the purchase was not approved, then decision 675 branches to the “no” branch whereupon, at step 685, the transaction is rejected and the merchant retains possession of the item.

FIG. 7 is a flowchart showing steps performed at the mobile device in checking predetermined authorized criteria. Processing commences at 700 whereupon, at step 705, the routine receives item data corresponding to the item that the user wishes to purchase from the calling routine (e.g., store type, category, item price, etc.). At step 710, the routine reads the predetermined spending limits that apply to the received item data from predetermined authorized criteria data store 430. The predetermined authorized criteria were previously established by the approver (the authorizing agent) as shown in FIG. 4 and as described in corresponding text.

A decision is made as to whether any predetermined authorized criteria regarding any predetermined time intervals have been established (decision 715). If any predetermined authorized criteria regarding time interval spending (e.g., daily limit, weekly limit, etc.) have been established, then decision 715 branches to the “yes” branch whereupon, at step 720, the system calculates the amount of money already spent by the user over the applicable time interval(s) and adds the price of the current item to the total. A decision is made as to whether purchase of the item would cause a time interval limit to be broken so that the item data does not meet the predetermined authorized criteria (decision 725). If purchase of the item would cause a time interval limit to be broken, then decision 725 branches to the “yes” branch whereupon processing returns to the calling routine with an indication (e.g., return code, etc.) that the item data does not meet (fall within) the predetermined authorized criteria at 730.

On the other hand, if there are no spending limits set for time intervals (with decision 715 branching to the “no” branch) or if purchase of the current item meets the established time interval spending limits (with decision 725 branching to the “no” branch), then processing of the item data continues. A decision is made as to whether the price of the item is greater than the predetermined limit set for purchase of any single item (decision 735). If the price of the item exceeds a predetermined authorized criteria established for a single item purchase, then decision 735 branches to the “yes” branch whereupon processing returns to the calling routine with an indication (e.g., return code, etc.) that the item data does not meet (fall within) the predetermined authorized criteria at 795. On the other hand, if the price of the item meets any predetermined authorized criteria set for a single item limit, then decision 735 branches to the “no” branch and processing of the item data continues.

A decision is made as to whether the store type is allowed (decision 740). As previously described, the store type may be a particular store name (e.g., “Walmart,” etc.) or may be a category of store, such as a clothing store, convenience store, etc. In addition, the store type may include the location of the store (e.g., disallowing purchases at any store in “Las Vegas,” etc.). If the store type is listed and allowed, then decision 740 branches to the “yes” branch whereupon a decision is made as to whether the item price is acceptable for the particular store type (decision 745). If the price is not acceptable for the particular store type, then decision 745 branches to the “no” branch whereupon processing returns to the calling routine with an indication (e.g., return code, etc.) that the item data does not meet (fall within) the predetermined authorized criteria at 750. If the store type is listed but purchases are not allowed from the store type, then decision 740 branches to the “no” branch whereupon processing returns to the calling routine with an indication (e.g., return code, etc.) that the item data does not meet (fall within) the predetermined authorized criteria at 795.

If either the store type is listed but the item price falls within the allowed limit for the store type (decision 745 branching to the “yes” branch) or the store type is not listed (decision 740 branching to the “not listed” branch), then a decision is made as to whether the item category is allowed (decision 760). If the item category (e.g., “video game,” “candy,” etc.) is not allowed, then decision 760 branches to the “no” branch whereupon processing returns to the calling routine with an indication (e.g., return code, etc.) that the item data does not meet (fall within) the predetermined authorized criteria at 795.

On the other hand, if the item category is listed and allowed, then decision 760 branches to the “yes” branch whereupon a decision is made as to whether the item price is acceptable for the particular item category (decision 765). If the price is not acceptable for the particular item category, then decision 765 branches to the “no” branch whereupon processing returns to the calling routine with an indication (e.g., return code, etc.) that the item data does not meet (fall within) the predetermined authorized criteria at 775. However, if either the price of the item is acceptable for the item category (decision 765 branching to the “yes” branch) or if the item category is not listed (decision 760 branching to the “not listed” branch), then processing returns to the calling routine with an indication (e.g., return code, etc.) that the item data meets (falls within) the predetermined authorized criteria at 780.

FIG. 8 is a flowchart showing steps performed at the mobile device to identify a preferred payment method for the purchase. Processing commences at 800 whereupon, at step 805, the various payment methods established for various transaction factors is retrieved from payment methods data store 810. At step 815, the item (transaction) price is compared to the various payment methods. A decision is made as to whether a payment method has been established to handle items (transactions) in this price range (decision 820). For example, a payment method using a low-interest credit card may have been established to purchase higher-priced items (e.g., items over $1,000). Likewise, a payment method using a debit card may have been established to purchase lower-priced items (e.g., items less than $10). If a payment method has been established to purchase items (transactions) within a price range that includes the price of the item being purchased, then decision 820 branches to the “yes” branch whereupon, at step 825, the payment method corresponding to the price of the item is selected and processing thereafter returns to the calling routine at 830.

Returning to decision 820, if a payment method has not been established to purchase items (transactions) within a price range that includes the price of the item being purchased, then decision 820 branches to the “no” branch whereupon, at step 835, the merchant where the item is being purchased (e.g., Sears, Walmart, etc.) is compared to payment methods that have been established for purchases at various merchants. For example, a store credit card may be established to make purchases when the user is buying an item at that store. A decision is made as to whether a payment method has been established when purchasing items from the merchant from which the item is being purchased (decision 840). If a payment method has been established to purchase items (transactions) from the merchant, then decision 840 branches to the “yes” branch whereupon, at step 845, the payment method that corresponds to the merchant is selected and processing thereafter returns to the calling routine at 850.

Returning to decision 840, if a payment method has not been established to purchase items (transactions) from this merchant, then decision 840 branches to the “no” branch whereupon, at step 855, the item category (e.g., clothing, food, electronics, etc.) is compared to payment methods that have been established for purchases of various item categories. For example, a credit card that provides better buyer protection may be established when the user is buying clothing or electronics so that the buyer can receive needed protection in case the purchased item is defective, etc. A decision is made as to whether a payment method has been established when purchasing items of this item category (decision 860). If a payment method has been established to purchase items (transactions) of this category, then decision 860 branches to the “yes” branch whereupon, at step 865, the payment method that corresponds to the item category is selected and processing thereafter returns to the calling routine at 870.

Returning to decision 860, if a payment method has not been established to purchase items (transactions) of this item category, then decision 860 branches to the “no” branch whereupon, at step 875, other transaction factors (e.g., geographic location of purchase, time of day, month, year, etc.) are compared to payment methods that have been established for such other transaction factors. A decision is made as to whether a payment method has been established when purchasing items of matching such other transaction factors (decision 880). If a payment method has been established to purchase items (transactions) matching such other transaction factors, then decision 880 branches to the “yes” branch whereupon, at step 885, the payment method that corresponds to the matching other transaction factors is selected and processing thereafter returns to the calling routine at 890. On the other hand, if no payment methods match the item transaction details, then decision 880 branches to the “no” branch whereupon, at step 895, a default payment method is selected and processing returns to the calling routine at 899.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method of approving purchases made with a mobile device, the method comprising:
receiving a set of predetermined authorized criteria from an authorizing agent;
receiving a purchase request from a user of the mobile device, wherein the purchase request relates to an item, and wherein the item corresponds to one or more types of item data;
comparing, by one or more processors, the item data to the set of predetermined authorized criteria;
generating, by at least one of the processors, a payment authorization in response to the item data meeting the predetermined authorized criteria;
in response to the item data not meeting the predetermined authorized criteria:
sending, over a network, a real-time interactive purchase request from the mobile device to the authorizing agent, wherein the purchase request includes the item data;
receiving, over the network, a response from the authorizing agent; and
generating the payment authorization in response to the response including a purchase approval from the authorizing agent.

2. The method of claim 1 wherein the set of predetermined authorized criteria is selected from the group consisting of an interval-based purchasing limit, an item amount purchasing limit, a store-type purchasing limit, and an item-category purchasing limit.

3. The method of claim 1 wherein the receiving of the purchase request further comprises:
identifying the item by scanning a barcode associated with the item, wherein the scanning is performed by an input component included in the mobile device.

4. The method of claim 1 wherein the generation of the payment authorization further comprises:
identifying a payment method based upon the item data, wherein the payment method corresponds to banking application data; and
transmitting the banking application data from the mobile device to a merchant device.

5. The method of claim 4 wherein the mobile device is a smart mobile phone that communicates with a merchant point-of-sale terminal, the method further comprising:
generating a close-proximity wireless message that includes the payment data, wherein the transmitting further comprises:
transmitting the close-proximity wireless message from the smart mobile phone to the merchant point-of-sale terminal using a close-proximity wireless transmitter included in the smart mobile phone.

6. The method of claim 1 further comprising:
prior to receiving the purchase request:
storing the received predetermined authorized criteria in a nonvolatile storage area accessible from the mobile device.

7. The method of claim 1 further comprising:
identifying the item by scanning a barcode associated with the item, wherein the scanning is performed by an input component included in the mobile device, the identifying resulting in an item identifier;
retrieving a recent purchase history from a memory of the mobile device, wherein the recent purchase history includes recent purchases made from the mobile device;
sending, from the mobile device, an item data request corresponding to the device identifier, wherein the item data request is sent to a network-based service using a wireless transmitter included in the mobile device;
receiving, at a wireless receiver included in the mobile device, the item data from the network-based service;
transmitting the received item data and the recent purchase history to the authorizing agent using the mobile device's wireless transmitter; and
receiving the response from the authorizing agent at the mobile device's wireless receiver.

8. A mobile information handling system comprising:
one or more processors;
a memory coupled to at least one of the processors;
a wireless transmitter, accessible by at least one of the processors, that transmits signals over a wireless network;
a wireless receiver, accessible by at least one of the processors, that receives signals over the wireless network; and
a set of instructions stored in the memory and executed by at least one of the processors, wherein the set of instructions perform actions of:
receiving a set of predetermined authorized criteria from an authorizing agent;
receiving a purchase request from a user of the mobile information handling system, wherein the purchase request relates to an item, and wherein the item corresponds to one or more types of item data;
comparing the item data to the set of predetermined authorized criteria;
generating a payment authorization in response to the item data meeting the predetermined authorized criteria;
in response to the item data not meeting the predetermined authorized criteria:
sending, over the wireless network, a real-time interactive purchase request from the mobile information handling system to the authorizing agent, wherein the purchase request includes the item data;
receiving, over the network, a response from the authorizing agent; and
generating the payment authorization in response to the response including a purchase approval from the authorizing agent.

9. The mobile information handling system of claim 8 wherein the set of predetermined authorized criteria is selected from the group consisting of an interval-based purchasing limit, an item amount purchasing limit, a store-type purchasing limit, and an item-category purchasing limit.

10. The mobile information handling system of claim 8 wherein the receiving of the purchase request further comprises:
identifying the item by scanning a barcode associated with the item, wherein the scanning is performed by an input component that is accessible to one or more of the processors and included in the mobile information handling system.

11. The mobile information handling system of claim 8 wherein the generation of the payment authorization further comprises:
identifying a payment method based upon the item data, wherein the payment method corresponds to banking application data; and
transmitting the banking application data from the mobile information handling system to a merchant device.

12. The mobile information handling system of claim 11 wherein the mobile information handling system is a smart mobile phone that communicates with a merchant point-of-sale terminal, wherein the set of instructions performs additional actions comprising:
generating a close-proximity wireless message that includes the payment data, wherein the transmitting further comprises
transmitting the close-proximity wireless message from the smart mobile phone to the merchant point-of-sale terminal using the wireless transmitter.

13. The mobile information handling system of claim 8 wherein the set of instructions performs additional actions comprising:
prior to receiving the purchase request:
storing the received predetermined authorized criteria in the mobile information handling system's memory.

14. The mobile information handling system of claim 8 wherein the set of instructions performs additional actions comprising:
identifying the item by scanning a barcode associated with the item, wherein the scanning is performed by an input component accessible by at least one of the processors which is included in the mobile information handling system, the identifying resulting in an item identifier;
retrieving a recent purchase history from the memory of the mobile information handling system, wherein the recent purchase history includes recent purchases made from the mobile device;
sending, from the mobile information handling system, an item data request corresponding to the information handling system identifier, wherein the item data request is sent to a network-based service using the wireless transmitter;
receiving, at the wireless receiver, the item data from the network-based service;
transmitting the received item data and the recent purchase history to the authorizing agent using the wireless transmitter; and
receiving the response from the authorizing agent at the wireless receiver.

15. A computer program product stored in a tangible computer readable storage medium, comprising functional descriptive material that, when executed by an information handling system, causes the information handling system to perform actions that include:
receiving a set of predetermined authorized criteria from an authorizing agent;
receiving a purchase request from a user of the mobile device, wherein the purchase request relates to an item, and wherein the item corresponds to one or more types of item data;
comparing the item data to the set of predetermined authorized criteria;
generating a payment authorization in response to the item data meeting the predetermined authorized criteria;
in response to the item data not meeting the predetermined authorized criteria:
sending, over a network, a real-time interactive purchase request from the mobile device to the authorizing agent, wherein the purchase request includes the item data;
receiving, over the network, a response from the authorizing agent; and
generating the payment authorization in response to the response including a purchase approval from the authorizing agent.

16. The computer program product of claim 15 wherein the set of predetermined authorized criteria is selected from the group consisting of an interval-based purchasing limit, an item amount purchasing limit, a store-type purchasing limit, and an item-category purchasing limit.

17. The computer program product of claim 15 wherein the receiving of the purchase request further includes additional actions comprising: identifying the item by scanning a barcode associated with the item, wherein the scanning is performed by an input component included in the mobile device.

18. The computer program product of claim 15 wherein the generation of the payment authorization further includes additional actions comprising:
identifying a payment method based upon the item data, wherein the payment method corresponds to banking application data; and
transmitting the banking application data from the mobile device to a merchant device.

19. The computer program product of claim 18 wherein the mobile device is a smart mobile phone that communicates with a merchant point-of-sale terminal, and wherein the actions further comprise:
generating a close-proximity wireless message that includes the payment data, wherein the transmitting further comprises:
transmitting the close-proximity wireless message from the smart mobile phone to the merchant point-of-sale terminal using a close-proximity wireless transmitter included in the smart mobile phone.

20. The computer program product of claim 15 wherein the actions further comprise:
prior to receiving the purchase request:
storing the received predetermined authorized criteria in a nonvolatile storage area accessible from the mobile device.

21. The computer program product of claim 15 wherein the actions further comprise:
identifying the item by scanning a barcode associated with the item, wherein the scanning is performed by an input component included in the mobile device, the identifying resulting in an item identifier;
retrieving a recent purchase history from a memory of the mobile device, wherein the recent purchase history includes recent purchases made from the mobile device;
sending, from the mobile device, an item data request corresponding to the device identifier, wherein the item data request is sent to a network-based service using a wireless transmitter included in the mobile device;
receiving, at a wireless receiver included in the mobile device, the item data from the network-based service;
transmitting the received item data and the recent purchase history to the authorizing agent using the mobile device's wireless transmitter; and
receiving the response from the authorizing agent at the mobile device's wireless receiver.

22. A method of approving purchases made with a mobile device, the method comprising:
scanning an item identifier corresponding to an item prior to checking out at a merchant location, wherein the scanning is performed using a camera included on the mobile device, and wherein the scanning results in a set of item data corresponding to the item;
comparing, by one or more processors, the item data to a set of predetermined authorized criteria received from an authorizing agent;
setting, by at least one of the processors, in a memory of the mobile device, a payment approval indicator corresponding to the item identifier in response to the item data meeting the predetermined authorized criteria; and
in response to the item data not meeting the predetermined authorized criteria:
sending, over a network, a real-time interactive purchase request from the mobile device to the authorizing agent, wherein the purchase request includes the item data;
receiving, over the network, a response from the authorizing agent; and
setting, in the memory of the mobile device, the payment approval indicator corresponding to the item identifier in response to the response including a purchase approval from the authorizing agent.

23. The method of claim 22 further comprising:
receiving, at the mobile device, a payment request from a merchant device in response to a request to purchase the item by a user of the mobile device, wherein the payment request includes the item identifier;
checking, at the mobile device, the payment approval indicator corresponding to the item identifier;
transmitting payment data from the mobile device to the merchant device in response to the payment approval being set; and
denying the payment request at the mobile device in response to the payment approval not being set.

24. The method of claim 22 further comprising:
displaying an approval message on a display of the mobile device in response to the payment approval being set.

25. The method of claim 22 wherein the mobile device is a smart mobile phone that communicates with a merchant point-of-sale terminal, and wherein the actions further comprise:
generating a close-proximity wireless message that includes the payment data, wherein the transmitting further comprises:
transmitting the close-proximity wireless message from the smart mobile phone to the merchant point-of-sale terminal using a close-proximity wireless transmitter included in the smart mobile phone; and
transmitting payment data from the smart mobile phone to the merchant point-of-sale terminal, wherein the payment data corresponds to banking application data.
